(19) United States
(12) Patent Application Publication
(10) Pub. No.: US 2017/0285514 A1
(43) Pub. Date: Oct. 5, 2017

(54) DEVELOPING DEVICE, PROCESS CARTRIDGE, AND IMAGE FORMING APPARATUS

(71) Applicant: CANON KABUSHIKI KAISHA, Tokyo (JP)

(72) Inventors: Takayoshi Kihara, Mishima-shi (JP); Shinichi Agata, Suntou-gun (JP)

(21) Appl. No.: 15/467,490

(22) Filed: Mar. 23, 2017

(30) Foreign Application Priority Data
Mar. 30, 2016 (JP) 2016-069327

(51) Int. Cl. G03G 15/08

(52) U.S. Cl. CPC G03G 15/0812; G03G 21/18; G03G 15/0808; G03G 2215/0617; G03G 2215/0869; G03G 2221/183

(57) ABSTRACT

A developing blade has a protrusion that protrudes toward a developing roller in an opposing portion facing the developing roller. When a height of the protrusion from an opposing surface that faces the developing roller at a position further toward a tip side than the protrusion is denoted by H (mm) and a length of the opposing surface extending toward the tip side perpendicular to an axial line direction of the developing roller is denoted by L (mm), when viewing a cross section perpendicular to a rotation axis of the developing roller, the following conditions are satisfied:

0.05≦H≦0.3, and

0.15≦L≦1.0.

### BACKGROUND OF THE INVENTION

### Field of the Invention

The present invention relates to a developing device for use in an electrophotographic image forming apparatus.

### Description of the Related Art

In an image forming apparatus, such as a printer, that uses an electrophotographic image forming system (electrophotographic process), an electrostatic image is formed on an electrophotographic photosensitive member (referred to hereinbelow as “photosensitive member”) serving as an image bearing member by uniformly charging the photosensitive member and selectively exposing the charged photosensitive member. The electrostatic image formed on the photosensitive member is visualized as a toner image by a toner serving as a developer. The toner image formed on the photosensitive member is then transferred to a recording material such as recording paper and a plastic sheet, and the toner image is then fixed to the recording material by applying heat or pressure to the toner image transferred to the recording material, thereby performing image recording. Such an image forming apparatus generally requires replenishment of the developer and maintenance of various process means. In order to facilitate replenishment of the developer and maintenance of various process means, the photosensitive body, a charging means, a developing means, a cleaning means, and the like, are combined in a frame to obtain a cartridge, thereby realizing a process cartridge removably attachable to the image forming apparatus main body. The process cartridge system makes it possible to provide an image forming apparatus excellent in usability.

Further, in recent years, color image forming apparatuses that form color images by using developers of a plurality of colors have become widespread. As a color image forming apparatus, an image forming apparatus of the so-called inline system is known in which photosensitive members corresponding to image forming operation using developers of a plurality of colors are disposed in a row along the surface movement direction of a transferred member onto which the toner image is to be transferred. In the color image forming apparatus of the inline system, a plurality of photosensitive members is disposed in a row in the direction (for example, a horizontal direction) intersecting a vertical direction (gravity direction). The inline image forming system is preferable in that it can easily meet the demands relating to the increase in image formation speed and the development of a multifunctional printer.

Further miniaturization and life extension of the image forming apparatus are also required. Some image forming apparatuses are configured such that the photosensitive member is disposed below an intermediate transfer member serving as a transfer member or below a recording material carrying member that transports the recording material as a transfer member. Where the photosensitive member is thus disposed below the intermediate transfer member or the recording material carrying member, it can be required to supply the developer to a developing chamber positioned above a developer accommodating unit in the developing device. In the abovementioned configuration, it is suggested to provide a supply member that is in contact with the developer carrying member and supplies the developer by rotating in the forward direction and to rotate the supply member so that the peripheral speed thereof is higher than that of the developer carrying member, thereby improving the circulation of the developer and suppressing the retention and deterioration of the developer (for example, Japanese Patent No. 5683527). With such a configuration, it is possible to suppress image defects (regulation defects, fogging, dripping, etc.) caused by deterioration of the developer.

Further, in the conventional pressure development system for regulating the developer in the developing device, the following configuration is suggested for the shape in the vicinity of the tip of a developer regulating member that extends from one end which is fixed to the frame in the direction opposite to the rotation direction of the developer carrying member and is in contact at the other end side with the surface of the developer carrying member (Japanese Patent Application Publication No. H11-272067). In this configuration, the opposing portion of the developer regulating member that faces the developer carrying member includes a pressure contact region that is in pressure contact with the developer carrying member and an opposing portion that is formed such as to face the developer carrying member at a distance therefrom on the upstream side, in the rotation direction of the developer carrying member, of the pressure contact region. With such a configuration, the regulating capability for forming a uniform thin-film layer of the developer is improved, density is stabilized, the developer is prevented from being fixedly attached to the developer regulating member, and stable image quality which is free from image defects such as streaks and fogging that occur with the passage of time can be obtained.

However, the following problem is associated with the developer supply method in which the supply member and the developer carrying member rotate in the same direction, as in Japanese Patent No. 5683527. When an intermediate gradation such as a halftone image is continuously outputted after an image with a high printing rate such as a solid image has been outputted, image defects (ghost images) can appear under the effect of the previous development history. In particular, under a low-temperature and low-humidity environment, the electrified charge quantity of the developer (referred to hereinbelow as “developer charge quantity”) after passing by the developer regulating member tends to increase. Further, a large difference easily occurs between the developer charge quantity of the developer carrying member after solid white printing in which the developer is not printed and the developer charge quantity of the developer carrying member after an image with a high printing rate, such as a solid image, has been outputted. Because of this difference in charge quantity, a γ curve changes when an intermediate gradation such as a halftone image is thereafter continuously outputted. In other words, the developing performance of the toner varies with respect to the potential difference (development contrast) between the photosensitive member and the developer carrying member and image defects (ghost images) can occur. This is because the developer supply member rotates in the same direction as the developer carrying member, and in Japanese Patent No. 5683527, the influence thereof is reduced as a result of the developer supply member rotating rapidly with respect to the developer carrying member. However, where attention is paid to capability of physically stripping the residual developer on the developer carrying member, this capability tends to be weaker as compared with that in the configuration in which the developer supply member rotates in the direction opposite to that of the developer carrying member. In other words, in the configuration disclosed in Japanese Patent No. 5683527, since the capability of physically stripping the residual developer on the developer carrying member is weak, image defects (ghost images) can occur under conditions of a low-temperature and low-humidity environment.

Further, Japanese Patent Application Publication No. H11-272067 suggests the configuration in which ranges of H and L are specified as H≦0.7L and H≦2.0 (mm), where H is the distance between the surface of the developer carrying member and the opposing portion at the tip of the developing blade and L is the length from the tip portion to the pressure contact region of the developing blade. However, in the developer supply method in which the developer supply member and the developer carrying member rotate in the same direction, it is not always possible to obtain stable and satisfactory image under the above-described relationship. In other words, image defects (ghost images) can appear under the effect of the previous development history due to the decrease in physical stripping capability.

### SUMMARY OF THE INVENTION

The developing device according to the present invention is a developing device for use in an image forming apparatus, the developing device comprising:

a frame that accommodates a developer;

a developer carrying member that is rotatably provided in an opening of the frame and carries and transports the developer;

a supply member that supplies the developer to the developer carrying member, the supply member being in contact with the developer carrying member and being provided rotatably so as to move in the same direction with respect to the rotating developer carrying member at a contact portion thereof; and

a regulating member that is blade-shaped, one end of the regulating member being fixed to the frame, and the other end of the regulating member, which is a free end extending in a direction opposite to a rotation direction of the developer carrying member, being in contact with the developer carrying member,

wherein the regulating member comprising,

an opposing portion that faces the developer carrying member, and

a protrusion that protrudes toward the developer carrying member in the opposing portion is provided;

wherein the opposing portion comprising an opposing surface that faces the developer carrying member at a position further toward a tip side of the other end than the protrusion; and

wherein a height of the protrusion from the opposing surface is denoted by H (mm) and a length of the opposing surface extending toward the tip side perpendicular to an axial line direction of the developer carrying member is denoted by L (mm), when viewing a cross section perpendicular to a rotation axis of the developer carrying member, the following conditions are satisfied:

0.05≦H≦0.3, and

0.15≦L≦1.0.

Further, the developing device according to another aspect of the present invention is a developing device for use in an image forming apparatus, the developing device comprising:

a frame that accommodates a developer;

a developer carrying member that is rotatably provided in an opening of the frame and carries and transports the developer;

a supply member that supplies the developer to the developer carrying member, the supply member being in contact with the developer carrying member and being provided rotatably so as to move in the same direction with respect to the rotating developer carrying member at a contact portion thereof; and

a regulating member that is blade-shaped, one end of the regulating member being fixed to the frame, and the other end of the regulating member, which is a free end extending in a direction opposite to a rotation direction of the developer carrying member, being in contact with the developer carrying member,

wherein

the regulating member comprising,

an opposing portion that faces the developer carrying member, and

a protrusion that protrudes toward the developer carrying member in the opposing portion facing the developer carrying member is provided;

wherein the opposing portion comprising an opposing surface that faces the developer carrying member at a position further toward a tip side of the other end than the protrusion; and

wherein a height of the protrusion from the opposing surface is denoted by H (mm) and a length of the opposing surface extending toward the tip side perpendicular to an axial line direction of the developer carrying member is denoted by L (mm), when viewing a cross section perpendicular to a rotation axis of the developer carrying member, the following conditions are satisfied:

0.05≦H≦0.1, and

0.15≦L≦1.0.

The process cartridge according to the present invention is a process cartridge that can be detachably attached to an apparatus main body of an image forming apparatus, the process cartridge comprising:

the developing device; and

an image bearing member on which a latent image that is to be developed by the developing device is formed.

The image forming apparatus according to the present invention for attaining the above object is an image forming apparatus that forms an image on a recording material, the image forming apparatus comprising:

the developing device; and

an image bearing member on which a latent image that is to be developed by the developing device is formed, wherein

a developer image which has been formed on the image bearing member by the development of the latent image is transferred to the recording material.

Further features of the present invention will become apparent from the following description of exemplary embodiments (with reference to the attached drawings).

### BRIEF DESCRIPTION OF THE DRAWINGS

FIG. 1 is a schematic cross-sectional view of the image forming apparatus according to Example 1;

FIG. 2 is a schematic cross-sectional view of the process cartridge according to Example 1;

FIG. 3 is an explanatory drawing illustrating the shape of the developing blade in Example 1;

FIG. 4 is an explanatory drawing illustrating a method for producing the developing blade in Example 1;

FIG. 5 is a schematic cross-sectional view of the vicinity of the regulating portion of the developing blade in Example 1; and

FIGS. 6A and 6B are diagrams of particle size distribution on a developing roller;

FIG. 7 is an explanatory drawing illustrating the shape of the developing blade in Comparative Example;

FIG. 8 is an explanatory drawing illustrating an appropriate range of the developing blade shape in Example 1; and

FIG. 9 is an explanatory drawing illustrating the toner charge quantity in Comparative Example and Example 1.

### DESCRIPTION OF THE EMBODIMENTS

Hereinafter, a description will be given, with reference to the drawings, of embodiments (examples) of the present invention. However, the sizes, materials, shapes, their relative arrangements, or the like of constituents described in the embodiments may be appropriately changed according to the configurations, various conditions, or the like of apparatuses to which the invention is applied. Therefore, the sizes, materials, shapes, their relative arrangements, or the like of the constituents described in the embodiments do not intend to limit the scope of the invention to the following embodiments.

### EXAMPLE 1

<1-1>: Over-All Schematic Configuration of Image Forming Apparatus

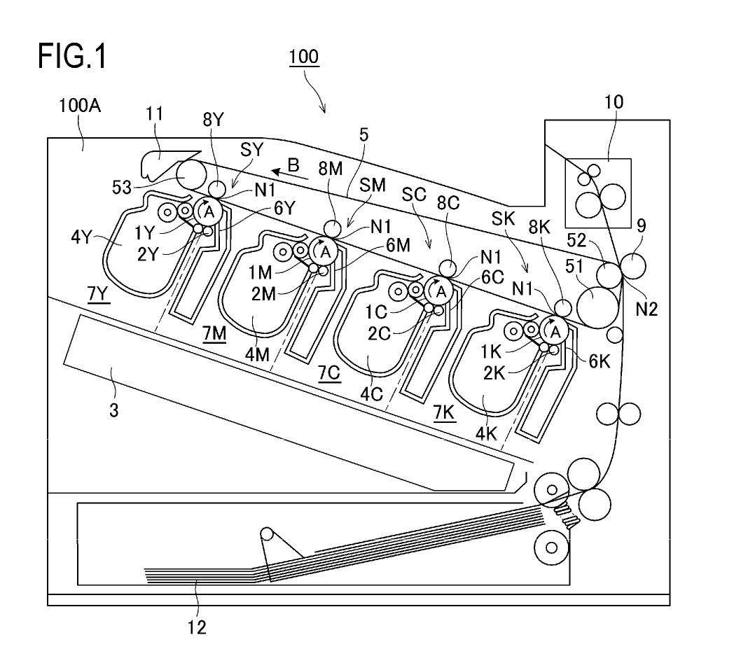

The overall configuration of the electrophotographic image forming apparatus (referred to hereinbelow as image forming apparatus) according to the examples of the present invention will be explained hereinbelow with reference to FIG. 1. FIG. 1 is a schematic cross-sectional view of an image forming apparatus 100 of the present example. The image forming apparatus 100 of the present example is a full-color laser printer using an inline system and an intermediate transfer system. The image forming apparatus 100 can form a full-color image on a recording material (for example, recording paper, plastic sheet, cloth, etc.) according to image information. The image information is inputted to an image forming apparatus main body 100A from an image reading device connected to the image forming apparatus main body 100A, or a host device such as a personal computer communicatively connected to the image forming apparatus main body 100A.

The image forming apparatus 100 has first, second, third and fourth image forming units SY, SM, SC, and SK for forming images for yellow (Y), magenta (M), cyan (C), and black (K) colors, respectively, as a plurality of image forming units. The first to fourth image forming units SY, SM, SC, and SK are disposed in a row in the direction intersecting the vertical direction. In the present example, the first to fourth image forming units SY, SM, SC, and SK have substantially the same configuration and operation, except for the color of the image to be formed. Therefore, in the following general description, the suffixes Y, M, C, and K assigned to the reference for indicating that an element is provided for a specific color are omitted unless special distinction is required.

In the present example, the image forming apparatus 100 has four drum-shaped electrophotographic photosensitive members, that is, photosensitive drums 1, as a plurality of image bearing members disposed side by side in the direction intersecting the vertical direction. The photosensitive drums 1 are rotationally driven by driving means (driving sources; not shown in the drawings) in the direction shown by an arrow A in the drawing (clockwise direction). A charging roller 2 as charging means for uniformly charging the surface of the photosensitive drum 1 and a scanner unit (exposure device) 3 as exposure means for forming an electrostatic image (electrostatic latent image) on the photosensitive drum 1 by laser irradiation according to image information are disposed on the periphery of the photosensitive drum 1. A developing unit (developing device) 4 as developing means for developing the electrostatic image as a toner image (developer image), and a cleaning member 6 as cleaning means for removing the untransferred toner remaining on the surface of the photosensitive drum 1 after the transfer are also disposed on the periphery of the photosensitive drum 1. An intermediate transfer belt 5 as an intermediate transfer member for transferring the toner image on the photosensitive drums 1 to a recording material 12 is disposed above the photosensitive drums 1 so as to face the four photosensitive drums 1.

In the present example, the developing unit 4 serving as a developing device uses a nonmagnetic mono-component developer toner as a developer. Further, in the developing unit 4 of the present example, the developing roller serving as a developer bearing member is brought into contact with the photosensitive drum 1 to perform reverse development. In the present example, the developing unit 4 develops the electrostatic image by causing the toner, which has been charged to the same polarity (negative polarity in the present example) as the charge polarity of the photosensitive drum 1, to adhere to the region (image region, exposure region) on the photosensitive drum 1 where the charge has been reduced by exposure.

In the present example, the photosensitive drum 1, the charging roller 2 as process means acting upon the photosensitive drum 1, the developing unit 4, and the cleaning member 6 are integrated so that those components are integrated as a cartridge and form a process cartridge 7. The process cartridge 7 can be detachably attached to the image forming apparatus 100 through mounting means such as a mounting guide or a positioning member provided on the image forming apparatus main body 100A. In the present example, the process cartridges 7 of all colors have the same shape, and the toners of yellow (Y), magenta (M), cyan (C), and black (K) colors are accommodated in the process cartridges 7 of respective colors. Further, in the present example, nonmagnetic mono-component toners are used as the developers.

The intermediate transfer belt 5 formed by an endless belt and serving as an intermediate transfer member is in contact with all of the photosensitive drums 1 and circulatory moves (rotates) in the direction shown by an arrow B in the drawing (counterclockwise direction). The intermediate transfer belt 5 is stretched over a drive roller 51, a secondary transfer opposing roller 52, and a driven roller 53 as a plurality of support means. Four primary transfer rollers 8 are disposed side by side as primary transfer means so as to face the photosensitive drums 1 on the inner peripheral surface side of the intermediate transfer belt 5. The primary transfer roller 8 presses the intermediate transfer belt 5 against the photosensitive drum 1 and forms a primary transfer portion N1 in which the intermediate transfer belt 5 and the photosensitive drum 1 are in contact with each other. Then, a bias of a polarity opposite to the regular charge polarity of the toner is applied to the primary transfer roller 8 from the primary transfer bias power source (high-voltage power source) as primary transfer bias application means (not shown in the drawing). As a result, the toner image on the photosensitive drum 1 is transferred (primary transfer) onto the intermediate transfer belt 5.

Further, a secondary transfer roller 9 is disposed as secondary transfer means at a position facing the secondary transfer opposing roller 52 on the outer peripheral surface side of the intermediate transfer belt 5. The secondary transfer roller 9 is pressed into contact with the secondary transfer opposing roller 52, with the intermediate transfer belt 5 being interposed therebetween, and forms a secondary transfer portion N2 where the intermediate transfer belt 5 and the secondary transfer roller 9 are in contact with each other. Then, a bias of a polarity opposite to the regular charge polarity of the toner is applied to the secondary transfer roller 9 from the secondary transfer bias power source (high-voltage power source) as secondary transfer bias application means (not shown in the drawing). As a result, the toner image on the intermediate transfer belt 5 is transferred (secondary transfer) onto the recording material 12.

For example, when a full-color image is formed, the process up to and including the aforementioned primary transfer is sequentially performed in the first to fourth image forming units SY, SM, SC, and SK, and toner images of each color are successively primary transferred in superposition on the intermediate transfer belt 5. The recording material 12 is thereafter transported to the secondary transfer portion N2 synchronously with the movement of the intermediate transfer belt 5. The four-color transfer image on the intermediate transfer belt 5 is secondary transferred as a whole onto the recording material 12 by the action of the secondary transfer roller 9 which is in contact with the intermediate transfer belt 5, with the recording material 12 being interposed therebetween. The recording material 12 onto which the toner image has been transferred is transported to the fixing device 10 as fixing means. The toner image is fixed to the recording material 12 by application of heat and pressure to the recording material 12 in the fixing device 10.

The primary untransferred toner remaining on the photosensitive drum 1 after the primary transfer step is removed and recovered by the cleaning member 6. The secondary untransferred toner remaining on the intermediate transfer belt 5 after the secondary transfer step is cleaned by an intermediate transfer belt cleaning device 11. It should be noted that the image forming apparatus 100 can form monochrome or multi-color images using only one desired image forming unit or only some (not all) image forming units.

<1-2>: Over-All Schematic Configuration of Process Cartridge

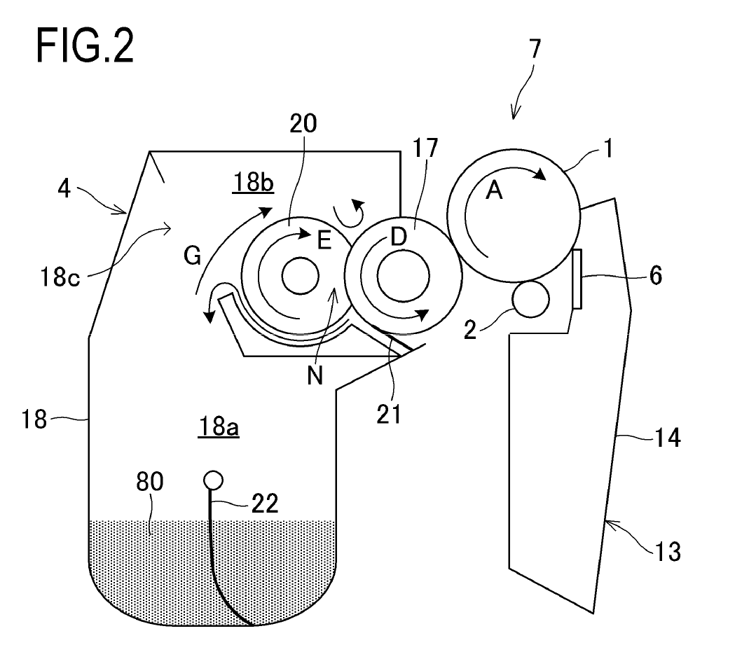

The overall configuration of the process cartridge 7 which is mounted on the image forming apparatus 100 of the present example will be explained hereinbelow with reference to FIG. 2. In the present example, the process cartridges 7 of each color have substantially the same configuration and operation, except for the type (color) of the toner accommodated therein. FIG. 2 is a schematic cross-sectional (main cross-sectional) view of the process cartridge 7 of the present example, which is viewed along the longitudinal direction (rotation axis direction) of the photosensitive drum 1. The posture of the process cartridge 7 in FIG. 2 is that after mounting on the image forming apparatus main body. Where mutual arrangement and orientation of members of the process cartridge and the like are described hereinbelow, those mutual arrangement and orientation and the like are assumed to relate to this posture.

The process cartridge 7 is configured by integrating a photosensitive member unit 13 including the photosensitive drum 1 or the like, and the developing unit 4 including the developing roller 17 or the like. The photosensitive member unit 13 has a cleaning frame 14 serving as a frame that supports various elements inside the photosensitive member unit 13. The photosensitive drum 1 is rotatably attached through a bearing (not shown in the drawing) to the cleaning frame 14. The photosensitive drum 1 is rotationally driven in the direction shown by the arrow A in the drawing (clockwise direction) in response to the image forming operation by transmitting the driving force of a driving motor serving as driving means (driving source; not shown in the drawing) to the photosensitive member unit 13. In the present example, the photosensitive drum 1, which is the principal component of the image forming process uses the organic photosensitive drum 1 in which an undercoat layer which is a functional film, a carrier generating layer, and a carrier transfer layer are sequentially coated on the outer peripheral surface of an aluminum cylinder.

Further, in the photosensitive member unit 13, the cleaning member 6 and the charging roller 2 are disposed so as to be in contact with the peripheral surface of the photosensitive drum 1. The untransferred toner removed from the surface of the photosensitive drum 1 by the cleaning member 6 falls down and is accommodated in the cleaning frame 14. The charging roller 2 serving as charging means is driven to rotate by pressing a roller portion made from an electrically conductive rubber into contact with the photosensitive drum 1. Here, a predetermined DC voltage is applied to the photosensitive drum 1 as a charging step in the core of the charging roller 2. As a result, a uniform dark potential (Vd) is formed on the surface of the photosensitive drum 1. A spot pattern of a laser beam emitted correspondingly to the image data by a laser from the aforementioned scanner unit 3 exposes the photosensitive drum 1, electric charges on the surface in the exposed segment are eliminated by the carriers from the carrier generating layer, and the electric potential decreases. As a result, an electrostatic latent image with a predetermined light potential (Vl) at the exposed segment and a predetermined dark potential (Vd) at the unexposed segment is formed on the photosensitive drum 1. In the present example, Vd=−500 V and V1=−100 V.

<1-3>: Explanation of Developing Unit

The developing unit 4 is provided with the developing roller 17 as a developer carrying member that carries a toner 80, a toner supply roller 20 as a supply member that supplies the toner to the developing roller 17, and a stirring and transporting member 22 as a transport member that transports the toner 80 to the toner supply roller 20. The developing unit 4 includes a developing container 18 as a frame to which the developing roller 17, the toner supply roller 20, and the stirring and transporting member 22 are rotatably assembled. The developing container 18 has a toner accommodating chamber 18a where the stirring and transporting member 22 is disposed, a developing chamber 18b where the developing roller 17 and the toner supply roller 20 are disposed, and a communication port 18c that links the toner accommodating chamber 18a and the developing chamber 18b so as to enable the movement of the toner. The developing chamber 18b is provided with a developing opening 30b as an opening for carrying the toner to the outside of the developing container 18, and the developing roller 17 is rotatably assembled to the developing container 18 in such a manner as to close the developing opening 30b. Thus, the toner accommodated in the developing container 18 is carried and transported by the rotating developing roller 17, passes through the developing opening 30b, moves to the outside of the developing container 18, and is used for developing the electrostatic latent image on the photosensitive drum 1. At that time, the amount of toner carried to the outside of the developing container 18 is regulated and adjusted by the developing blade 21. The toner accommodating chamber 18a is positioned below, in the gravity direction, the developing chamber 18b. A position where the developing blade 21 is in contact with the developing roller 17 is below the rotation center of the developing roller 17 and also between the rotation center of the developing roller 17 and the rotation center of the toner supply roller 20 in the horizontal direction. In the present example, a nonmagnetic mono-component toner is used as the toner 80.

The stirring and transporting member 22 stirs the toner accommodated inside the toner accommodating chamber 18a and transports the toner in the direction shown by an arrow G in the drawing toward the upper portion of the toner supply roller 20 in the developing chamber 18b. In the present example, the stirring and transporting member 22 is rotationally driven at a revolution speed of 60 rpm. The developing roller 17 and the photosensitive drum 1 rotate such that the surfaces thereof move in the same direction (upward direction in the present example) in the opposing portion. Further, in the present example, the developing roller 17 is disposed in contact with the photosensitive drum 1, but a configuration may be also used in which the developing roller 17 is disposed close to the photosensitive drum 1 at a predetermined distance therefrom. In the present example, the toner charged negatively by triboelectric charging with respect to a predetermined DC bias applied to the developing roller 17 is transferred only to a light potential portion in the developing region which is in contact with the photosensitive drum 1, from the potential difference thereof, thereby visualizing the electrostatic latent image. In the present embodiment, a potential difference ΔV=200 V with the light potential portion is formed and a toner image is formed by applying V=−300 V to the developing roller.

The toner supply roller 20 and the developing roller rotate in a direction in which the respective surfaces move from the upper end to the lower end of a nip portion N. Thus, the toner supply roller 20 rotates in the direction of an arrow E in the drawing (clockwise direction), and the developing roller 17 rotates in the direction of an arrow D. The toner supply roller 20 is an elastic sponge roller in which a foam layer is formed on the outer periphery of a conductive core metal. The toner supply roller 20 and the developing roller 17 are brought into contact with each other with a predetermined penetration amount, that is, the toner supply roller 20 has a recess amount ΔE by which it is recessed by the developing roller 17, as shown in FIG. 2. The toner supply roller 20 and the developing roller 17 rotate in the same direction at the nip portion N with a difference in peripheral speed (the peripheral surface of the toner supply roller 20 moves faster than the peripheral surface of the developing roller 17). Because of such operation, the toner is supplied by the toner supply roller 20 to the developing roller 17. At this time, the toner supply amount to the developing roller can be adjusted by adjusting the potential difference between the toner supply roller and the developing roller.

In the present example, the toner supply roller is rotationally driven at a revolution speed higher than that of the developing roller, the revolution speed of the toner supply roller being 300 rpm and that of the developing roller being 200 rpm. Further, DC biases are applied so that the toner supply roller with respect to the developing roller is at ΔV=−50 V. In other words, V=−300 V is applied to the developing roller and V=−350 V is supplied to the toner supply roller. As a result, the toner is easily electrically supplied from the toner supply roller to the developing roller. Further, in the present example, both the developing roller 17 and the toner supply roller 20 had an outer diameter of 15 mm, and the penetration amount of the developing roller 17 into the toner supply roller 20, that is, the recess amount ΔE by which the toner supply roller 20 is recessed by the developing roller 17 is set to 1.0 mm. Further, the toner supply roller and the developing roller were disposed to have the same center height.

<1-4>: Seal Configuration of Developing Unit

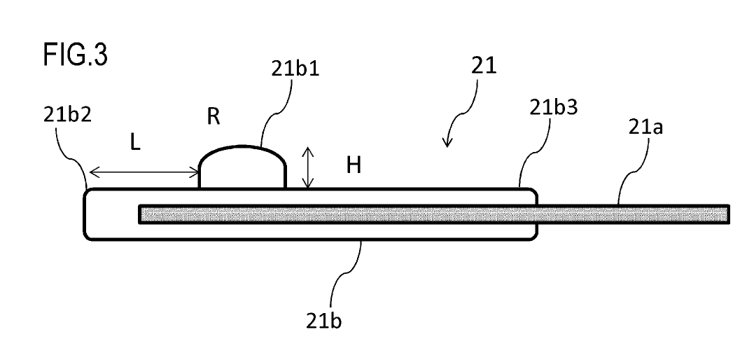

The configuration of the developing blade 21 in the present example will be explained hereinbelow in detail with reference to FIG. 3. FIG. 3 is a schematic cross-sectional view for explaining the shape of the developing blade 21 in the present example. The developing blade 21 is a blade-shaped member having a support member 21a and a resin layer 21b which is integrally attached to the tip side of the support member 21a. The support member 21a is fixed at one end portion thereof in the lateral direction to the developing container 18 with a fastener such as a screw and is free at the other end portion in a cantilever fashion. Thus, the one end portion of the support member 21a is a base end portion in the developing blade 21, and the other end portion of the support member 21a where the resin layer 21b is formed is a tip portion in the developing blade 21 which is in sliding contact with the developing roller 17. Further, the tip side of the support member 21a faces the upstream side in the rotation direction of the developing roller 17, in other words, in a direction from the downstream side to the upstream side in the rotation direction of the developing roller 17 in the tangential direction of the developing roller 17. Thus, the developing blade 21 is disposed to face in the counter direction with respect to the rotation of the developing roller 17.

The toner is triboelectrically charged by rubbing between the developing blade 21 and the developing roller 17 to apply an electric charge thereto, and at the same time the toner layer thickness is regulated. Further, in the present example, a predetermined voltage is applied to the developing blade 21 from a blade bias power source (not shown in the drawing), and the toner coat is stabilized. In the present example, a voltage of V=−500 V is applied as a blade bias.

The support member 21a is a plate-shaped elastic member. A metal thin plate (sheet metal), namely, a stainless steel (SUS) thin plate, was used to impart elasticity (springiness) to the support member 21a. However, in addition to stainless steel, phosphor bronze, an aluminum alloy, etc., may be also used. In the present example, a sheet metal with a width of 226 mm in the longitudinal direction, a width of 9.6 mm in the lateral direction perpendicular to the longitudinal direction, and a thickness of 0.08 mm is used as the support member 21a. The developing blade 21 forms a contact pressure by using the spring elasticity of the thin plate which is the support member 21a, and the surface of the resin layer 21b is in contact with the toner and the developing roller 17. The material of the support member 21a of the developing blade 21 is not limited to SUS, and a thin metal plate such as a phosphorus bronze or aluminum plate may be used.

The resin layer 21b is formed so as to cover the other end portion of the support member 21a from the side of the surface (front surface side) of the support member 21a opposing the developing roller 17 to the surface (back surface) side opposing an end portion seal 40 through the tip of the other end portion. The resin layer 21b is fabricated by coating the support member 21a with polyurethane. In addition to the above, polyamide, polyamide elastomer, polyester, polyester elastomer, polyester terephthalate, urethane rubber, urethane resin, silicone rubber, silicone resin, and melamine resin may be used individually or in combinations of two or more thereof for the material of the resin layer 21b. Various additives such as roughening particles can be contained, if necessary, in these materials. A metal may be also used for the coat layer.

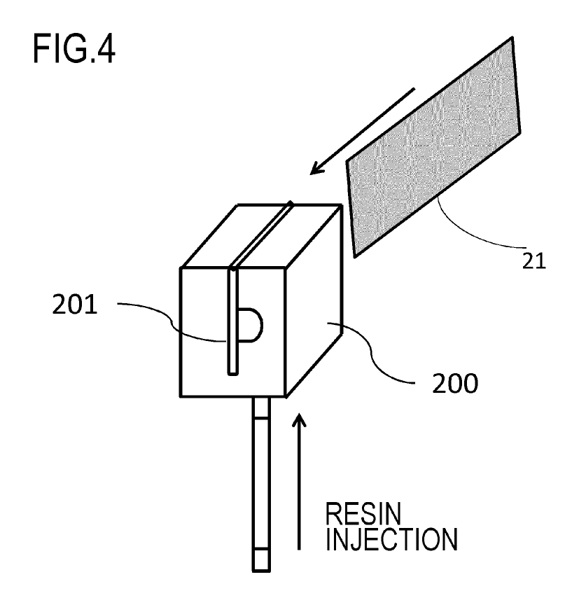

FIG. 4 is a schematic perspective view for explaining a method for producing the developing blade in the present example. As shown in FIG. 4, the support member 21a, which is a thin plate-spring-shaped plate made of SUS having a width of about 10 mm, is transported at a constant speed and passes through the interior of a recess 201 of a mold 200. The interior of the recess 201 is machined to a blade tip shape. When the support member 21a passes through the interior of the recess 201 of the mold 200, the resin layer 21b of a desired shape is molded on the tip portion of the support member 21a by injecting a resin from below, which is liquefied by heating, while applying a certain pressure. The developing blade 21 having the tip shape formed by the resin layer 21b is cooled after passing through the mold and cut to the desired longitudinal size to complete the production of the developing blade 21.

Conditions relating to the shape of the tip of the developing blade 21 (shape of the resin layer 21b) differ depending on, for instance, the setting of the transport speed and viscosity and flowability of the liquefied resin, but by fabricating the developing blade by using the abovementioned features, it is possible to produce stably a blade with a uniform tip shape in the longitudinal direction. In the present example, a thermoplastic resin is continuously and integrally formed in the above-described manner on the thin plate made of SUS. The advantage of such a process is that the accuracy of the tip shape is stabilized and also the productivity of the developing blade is improved. In the present example, the developing blade is fabricated using the thermoplastic resin, but this is not a limitation and a thermosetting resin may be also used. In this case, a developing blade which is uniform in the longitudinal direction and has a high accuracy of the tip shape can be fabricated by using a mold, which has been machined in advance to the tip shape, inserting the support member 21a in the form of a thin metal plate, casting, heating and curing the resin, and removing the blade from the mold.

A protrusion 21b1 protruding toward the developing roller 17 is provided as part of the resin layer 21b at a predetermined distance from the tip (other end portion side of the support member 21a, upstream side in the rotation direction of the developing roller 17) in the opposing portion of the resin layer 21b that faces the developing roller 17. An opposing portion 21b2 on the tip side with respect to the protrusion 21b1, that is, on the upstream side in the rotation direction of the developing roller 17, faces the developing roller 17 through a predetermined space. The resin layer on the side of the protrusion 21b1 (base end side of the developing blade 21) which is opposite to the tip side thereof, that is, the downstream side in the rotation direction of the developing roller 17, is a straight portion 21b3 that is formed in a planar shape and faces the developing roller 17 through a predetermined space.

The height of the step between the protrusion 21b1 and the opposing portion 21b2 (height of the protrusion 21b1), that is, the distance between the pressure contact surface of the developing blade 21 that is in pressure contact with the developing roller 17 and the opposing surface that is farther from the developing roller 17 than the pressure contact surface is denoted by H (mm) (referred to hereinbelow as “protrusion height H”). The length of the opposing portion 21b2 in the lateral direction is denoted by L (mm) (referred to hereinbelow as “length L”). The length L is the length of the opposing portion 21b2 extending in the rotation direction of the developing roller 17, in other words, toward the tip side (free end side) perpendicular to the rotation axis line (longitudinal direction) of the developing roller 17. Further, the contact radius of the protrusion 21b1 of the developing blade 21 that is in contact with the developing roller 17, that is, the curvature radius of the circular arc forming the tip surface of the protrusion 21b1, when viewed in the cross section perpendicular to the rotation axis of the developing roller 17, that is, in the cross section shown in FIG. 3, is denoted by R (mm). The curvature radius R is preferably set to at least 1.00 mm to ensure stable contact of the developing blade 21 with the developing roller 17 over a certain contact width.

<1-5>: Test

The following test was performed in the present example and a comparative example. In the configuration of the present example, a test to evaluate the development ghost reduction was performed with respect to a plurality of developing blades produced by variously combining parameters, such as the protrusion height H (mm) and length L (mm), of the shape of the above-described surface protrusion of the developing blade 21. Samples were fabricated in which the contact radius R was fixed to 1.0 mm and the protrusion height H and length L were varied.

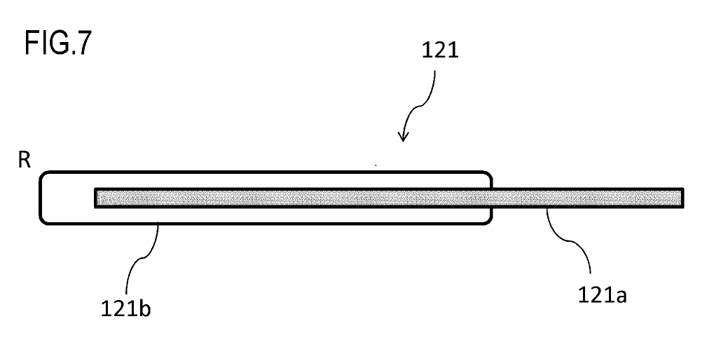

FIG. 7 is a schematic cross-sectional view illustrating the configuration of a developing blade 121 used as the comparative example in the present test. As shown in FIG. 7, the developing blade 121 used in the comparative example had a flat shape, without a protrusion, at a toner regulating surface in a resin layer 121b formed at the tip of a support member 121a, and the tip had a shape with a radius R of 0.2 mm. Features of the process cartridge other than the developing blade, and the entire configuration of the image forming apparatus are the same as in the present example.

The apparatus assembled to predetermined dimensional settings was allowed to stand overnight in a low-temperature and low-humidity environment (15° C., 10% RH) to adjust sufficiently to the environment, and the electrified charge quantity Q/M (μC/g) on the developing roller and the toner layer thickness amount M/S (mg/cm²) in the comparative example and example were measured. The developing blade of the present example had the following specifications: protrusion height H: 0.1 mm, length L: 0.3 mm, contact radius R: 1.0 mm.

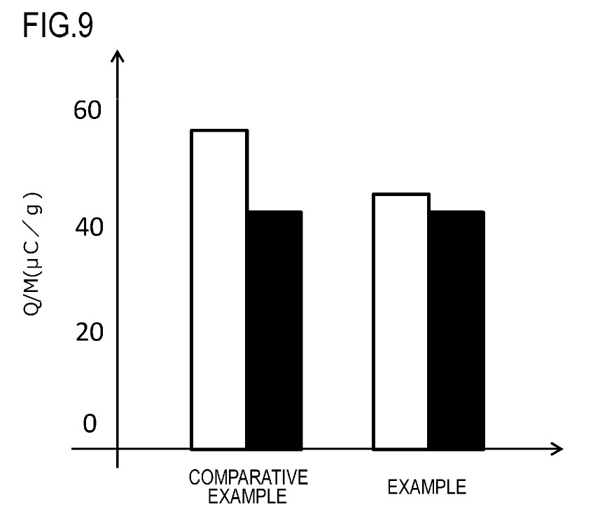

FIG. 9 shows the results obtained in measuring the electrified charge quantity (referred to hereinbelow as “charge quantity”) of the toner on the developing roller under the abovementioned conditions. The white bar graph shows the charge quantity on the developing roller after solid white printing, and the black bar graph shows the charge quantity on the developing roller after solid black printing. It follows from the drawing that there is a difference in charge quantity of about 15 μC/g to 20 μC/g on the developing roller using the developing blade of the comparative example between after solid white printing and after solid black printing. In comparison therewith, it is clear that the difference in the charge quantity on the developing roller using the developing blade of the present example between after solid white printing and after solid black printing is reduced to about 5 μC/g.

Further, the toner layer thickness amount, M/S, in the comparative example was 0.28 mg/cm² after solid white printing and 0.3 mg/cm² after solid black printing. The toner layer thickness amount, M/S, in the present example was 0.3 mg/cm² after solid white printing and 0.32 mg/cm² after solid black printing. Comparing the difference in the toner layer thickness, it was almost the same and no large difference could be found.

It follows from the above, that the difference in the charge quantity on the developing roller between after solid white printing and after solid black printing is reduced as a result of using the developing blade of the present example, and therefore, development ghosts can be reduced. Further, in the present example, the developing blade 21, the developing roller 17, the toner supply roller 20, the toner, and applied biases were set such that the toner charge quantity on the developing roller after solid black printing was about 40 μC/g, but such settings are not limiting. It is important that the difference in the charge quantity on the developing roller between after solid white printing and after solid black printing be small. Therefore, the development ghosts can be reduced by adjusting the toner charge quantity on the developing roller to a range of about 20 μC/g to 80 μC/g, the specific range depending on conditions such as the usage environment, number of prints, developing configuration, and bias settings.

Further, in the present example, the developing blade 21, the developing roller 17, the toner supply roller 20, the toner, and applied biases were set such that the toner layer thickness amount on the developing roller after solid white printing and after solid black printing was about 0.3 mg/cm², but such settings are not limiting. The toner layer thickness amount on the developing roller is determined to obtain the desired solid density. Therefore, the development ghosts can be reduced, without any adverse effect, by adjusting the toner layer thickness amount on the developing roller to a range of about 0.2 mg/cm² to 0.6 mg/cm², the specific range depending on conditions such as the usage environment, number of prints, developing configuration, and bias settings.

<1-5>: Mechanism of Development Ghost Reduction

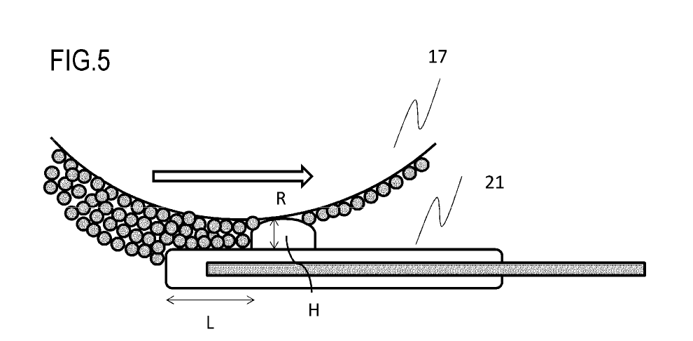

The mechanism of reducing the development ghosts in the present example will be explained hereinbelow with reference to FIG. 5. FIG. 5 is a schematic cross-sectional view explaining how the toner is regulated by the developing blade 21. This drawing shows schematically, in the cross-section viewed in the axial direction of the developing roller 17, the configuration of the developing roller 17, the developing blade 21, and the toner in the vicinity of the toner regulating portion. Further, in the drawings explaining the present example, each member is shown schematically in order to facilitate the understanding of the device configuration, and the dimensional relationship between the members is not strictly shown in the drawings.

As described hereinabove, the development ghosts are caused by the occurrence of a large difference between the toner charge quantity on the developing roller in a solid white image in which no toner is consumed and the toner charge quantity on the developing roller after outputting an image with a high printing rate such as a solid image that consumes a large amount of toner.

As shown in FIG. 5, the toner supplied from the toner supply roller 20 to the developing roller 17 passes through the contact nip portion N of the toner supply roller 20 and the developing roller 17 and is thereafter carried and transported as a precoat amount on the developing roller 17. The transported toner is regulated to a predetermined toner coat layer by passing by the developing blade 21. As a result, in a region (referred to hereinbelow as “wedge portion”) formed with the length L (mm) and the protrusion height H (mm) in the opposing portion 21b2 at a position further toward the tip side than the protrusion 21b1 of the resin layer 21b of the developing blade 21, the toner that was regulated to the desired layer thickness and could not pass therethrough is held in a tightly pressed state. Where the toner is in the tightly pressed state at all times, replacement of the toner accumulated in the wedge portion including the undeveloped toner adhered to the developing roller 17 is actively performed. For this reason, rubbing between the toner particles is increased, charge exchange is actively performed, and static elimination effect, that is, the decrease in the amount of toner having a high charge, is obtained even with a toner which tends to be in a highly charged state, such as the undeveloped toner or a toner with a small particle size. As a result, the particle size of the toner on the developing roller 17 after passing by the developing blade 21 does not depend on the amount of the undeveloped toner or the charge state, thus the particle size selectivity can be suppressed.

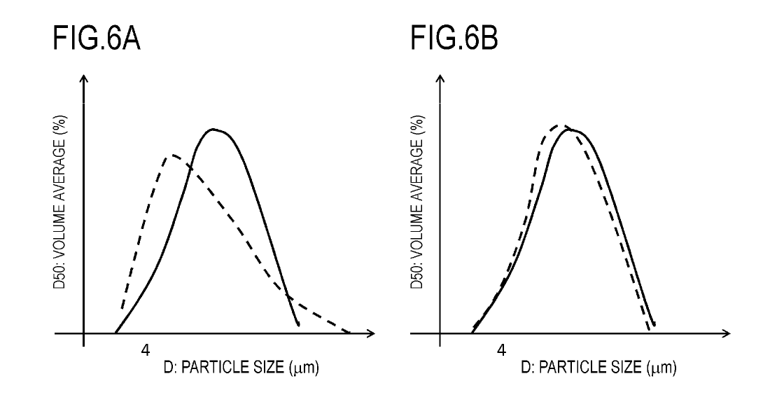

FIGS. 6A and 6B show the particle size distribution of the toner on the developing roller 17 after passing by the developing blade in the present example.

FIG. 6A shows the particle size distribution on the developing roller after solid white printing and after solid black printing in the case of using a developing blade without a protrusion on the toner regulating surface as a conventional example (FIG. 7). Measurements were performed using Multisizer III manufactured by Beckman Coulter, Inc. In the measurements, a single-color (black) toner present on the developing roller was collected. The particle size D (μm) of the toner is plotted against the abscissa, and the presence probability (%) of a volume average (D50) is plotted against the ordinate. A broken line in the drawing is the particle size distribution on the developing roller 17 after solid white printing, and a solid line is the particle size distribution on the developing roller 17 after solid black printing. It follows from the drawing, that the average center particle size after solid white printing is less than that after solid black printing. The average center particle size on the developing roller 17 after solid white printing is 5.4 μm, and it is clear that the proportion of fine-particle toner with a particle size of not more than 4 μm in the particle size distribution after solid white printing has increased over that in the particle size distribution after solid black printing. Further, the average center particle size on the developing roller 17 after solid black printing is 6.1 μm. From this, it is clear that on the developing roller 17, the average particle size of the toner on the developing roller after solid white printing becomes less than that after solid black printing. Therefore, the toner charge quantity on the developing roller becomes higher after solid white printing.

FIG. 6B shows the particle size distribution on the developing roller 17 after solid white printing and after solid black printing in the case of using the developing blade 21 of the present example in which a protruding shape is provided on the toner regulating surface (FIG. 3). The relationship between the abscissa, ordinate, broken line and solid line is the same as in FIG. 6A. It follows from the drawing, that the toner particle size distribution after solid white printing and the toner particle size distribution after solid black printing show almost the same tendency. The average center particle size on the developing roller after solid white printing is 5.9 μm, and the average center particle size on the developing roller after solid black printing is 6.1 μm. From this, it is clear that the average particle size of the toner after solid white printing and after solid black printing on the developing roller 17 is almost the same when using the developing blade 21 of the present example.

The toner charge quantity on the developing roller at this time shows the same tendency as in the present example illustrated by FIG. 9. In other words, the toner charge quantity after solid white printing is 45 μC/g, the toner charge quantity after solid black printing is 40 μC/g, the difference therebetween is about 5 μC/g, and the toner charge quantity after solid white printing and after solid black printing is almost the same. Therefore, the difference in the toner charge quantity on the developing roller between when the toner is printed and when the toner is not printed can be suppressed, thereby making it possible to reduce the development ghosts.

(1) Leading End Density Stability Evaluation of Solid Image

As a method for evaluating image defects (development ghosts), the decrease in image density in the case of outputting solid images with a high printing rate was measured to evaluate the density stability at the leading end of a solid image. In the present example, as described hereinabove, a bias that facilitates supply of the toner to the developing roller is electrically applied to the toner supply roller. The evaluation was performed after allowing the image forming apparatus to stand for 1 day under an evaluation environment of 15.0° C. and 10% RH to adjust the apparatus to the environment. In the print evaluation test, first, a solid white image which does not consume the toner was printed, and then a solid black image was continuously outputted and the evaluation was performed from the difference in density between the output leading end of the solid black image and the solid black image after one rotation of the developing roller. The measurement was performed using Spectordensitometer 500 manufactured by X-Rite Inc. In the printing test and image evaluation, a single-color (black) image was outputted.

A: the difference in density between the leading end of the recording material and after one rotation of the developing roller in a solid image is less than 0.2;

B: the difference in density between the leading end of the recording material and after one rotation of the developing roller in a solid image is 0.2 to less than 0.3; and

C: the difference in density between the leading end of the recording material and after one rotation of the developing roller in a solid image is at least 0.3.

(2) Presence/Absence of Dripping

After the evaluation described in (1) hereinabove, the image forming apparatus which underwent the durability test was disassembled, and it was investigated and evaluated whether or not the toner dropped on the developing blade. As a condition of the durability test, 10,000 sheets with images in which a horizontal line periodically appeared with an image printing rate of 0.5% were intermittently printed in an evaluation environment of 15.0° C. and 10% RH. The intermittent printing, as referred to herein, means that next printing is performed after a standby state following the previous printing. The occurrence of “dripping” in this evaluation refers to a state in which the toner is not held on the developing roller and the toner is falling on the developing blade at a portion of the developing roller downstream of the toner regulating portion. Where image formation is continued in the state in which toner dripping has occurred, contamination develops inside of the image forming apparatus main body and on the recording material and image quality deteriorates.

<Test Results>

The settings and evaluation results of the examples are shown in Table 1. In the toner dripping column in the table, ◯ indicates that toner dripping has not occurred, and × indicates that toner dripping has occurred.

TABLE 1
Evaluation results on image defects in Example 1

| | Protrusion | | Leading end | |
|---|---|---|---|---|
| | height H | Length L | density | Toner |
| | (mm) | (mm) | stability | dripping |
| Comparative | 0 | 0 | C | ◯ |
| Example | | | | |
| Example | 0.05 | 0.15 | A | ◯ |
| | | 0.30 | A | ◯ |
| | | 1.0 | A | ◯ |
| | | 1.5 | A | X |
| | 0.1 | 0.15 | A | ◯ |
| | | 0.30 | A | ◯ |
| | | 1.0 | A | ◯ |
| | | 1.5 | A | X |
| | 0.3 | 0.15 | B | ◯ |
| | | 0.30 | B | ◯ |
| | | 1.0 | B | ◯ |
| | | 1.5 | B | X |
| | 0.35 | 0.15 | C | ◯ |
| | 1.0 | 0.15 | C | ◯ |
| | | 1.5 | C | X |
| | 1.5 | 0.15 | C | ◯ |
| | | 1.5 | C | X |

First, the results of the comparative example will be described. In the comparative example, a developing blade configured not to have a protruding shape on the toner regulating surface is used. In the configuration of the comparative example, as described hereinabove, a difference occurs in the toner charge quantity on the developing roller between after solid white printing and after solid black printing, and density stability at the leading end of the recording material (leading end of the image) is difficult to ensure.

Next, the results of the example will be described. In the present example, a developing blade configured to have a protruding shape arranged on the toner regulating surface, as shown in FIG. 3, is used. The test was conducted at a protrusion height H of 0.05 mm to 1.5 mm by changing the length L from 0.15 mm to 1.5 mm. When the protrusion height H was 0.05 mm to 0.1 mm, a rank A could be ensured for density stability at the leading end with the length L from 0.15 mm to 1.5 mm. However, when the length L was 1.5 mm, toner dripping occurred. When the protrusion height H was 0.3 mm, a rank B could be ensured for density stability at the leading end with the length L from 0.15 mm to 1.5 mm. However, when the length L was 1.5 mm, toner dripping occurred. Where the protrusion height H was 0.35 mm, although no toner dripping occurred when the length L was 0.15 mm, density stability at the leading end could not be ensured. Where the protrusion height H was 1.0 mm and 1.5 mm, although no toner dripping occurred when the length L was 0.15 mm, density stability at the leading end could not be ensured. Further, when the length L was 1.5 mm, additional toner dripping occurred.

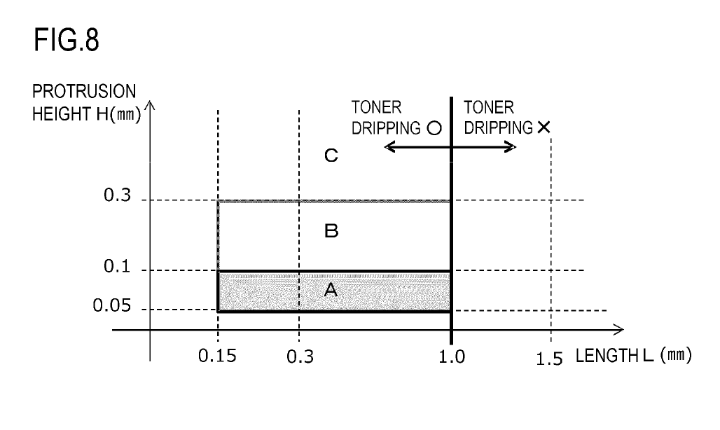

A graph summarizing the appropriate range of the developing blade configuration on the basis of these test results is shown in FIG. 8. FIG. 8 shows an appropriate range of the shape of the developing blade in the present example. The length L (mm) is plotted against the abscissa, and the protrusion height H (mm) is plotted against the ordinate. A to C in the drawing indicate the result ranges of density stability at the leading end which were obtained from the test results. It could be confirmed that no toner dripping occurred when the length L (mm) was not more than 1.0 mm. In summary, the following ranges were found to be appropriate.

0.05≦H≦0.3,

0.15≦L≦1.0.

The density stability on the leading end is even better (rank A) and also no toner dripping occurred in the following ranges:

0.05≦H≦0.1,

0.15≦L≦1.0.

Therefore, the highest effect of reducing the development ghosts is attained in these ranges. Thus, the development ghosts can be reduced by using the developing blade with the height and length within these ranges. That is, a satisfactory state of the toner charge quantity can be obtained with a simple configuration, and a high-quality image can be stably formed.

As follows from the above, in a developing device in which the developing roller and the toner supply roller rotate so as to move in the same direction in the contact region thereof, development ghosts can be reduced by providing the developing blade with the following configuration. Thus, a protrusion is provided at the tip portion of the developing blade, the protrusion height H (mm) is 0.05≦H≦0.3 and the length L (mm) of the opposing surface at a position further toward the tip side than the protrusion is 0.15≦L≦1.0. Further, the development ghosts can be also reduced with the configuration of the developing blade which is different from that of the present example, for example, with the configuration in which the contact radius R (mm) of the protrusion is R>1.0 and the configuration of the developing blade described in Japanese Patent Application Publication No. H11-272067, by setting the shape of the developing blade in the abovementioned ranges.

Further, in the present example, an image forming apparatus capable of forming color images is described, but the present invention is not limited thereto. The same effect can be also obtained with the image forming apparatus capable of forming monochromatic images which is configured such that the toner supply roller using a nonmagnetic mono-component toner rotates in the same direction as the developing roller. Further, in the present example, a printer is exemplified as the image forming apparatus, but the present invention is not limited thereto. For example, the present invention is also applicable to other image forming apparatus such as copiers, facsimile machines, or multifunction machines combining functions thereof.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-069327, filed Mar. 30, 2016, which is hereby incorporated by reference herein in its entirety.

What is claimed is:

1. A developing device for use in an image forming apparatus, the developing device comprising:
a frame that accommodates a developer;
a developer carrying member that is rotatably provided in an opening of the frame and carries and transports the developer;
a supply member that supplies the developer to the developer carrying member, the supply member being in contact with the developer carrying member and being provided rotatably so as to move in the same direction with respect to the rotating developer carrying member at a contact portion thereof; and
a regulating member that is blade-shaped, one end of the regulating member being fixed to the frame, and the other end of the regulating member, which is a free end extending in a direction opposite to a rotation direction of the developer carrying member, being in contact with the developer carrying member,
wherein the regulating member comprising,
an opposing portion that faces the developer carrying member, and
a protrusion that protrudes toward the developer carrying member in the opposing portion is provided;
wherein the opposing portion comprising an opposing surface that faces the developer carrying member at a position further toward a tip side of the other end than the protrusion; and
wherein a height of the protrusion from the opposing surface is denoted by H (mm) and a length of the opposing surface extending toward the tip side perpendicular to an axial line direction of the developer carrying member is denoted by L (mm), when viewing a cross section perpendicular to a rotation axis of the developer carrying member, the following conditions are satisfied:
0.05≦H≦0.3, and
0.15≦L≦1.0.

2. The developing device according to claim 1, wherein
the frame has a developing chamber, which is provided with the opening and in which the developer carrying member and the supply member are disposed, and an accommodating chamber, which is below the developing chamber, communicates with the developing chamber, and accommodates the developer,
the developing device further comprising a transport member that is rotatably disposed in the accommodating chamber and transports the developer from the accommodating chamber to the developing chamber.

3. The developing device according to claim 1, wherein
a revolution speed of the supply member is higher than that of the developer carrying member.

4. The developing device according to claim 1, wherein
a position, at which the protrusion of the regulating member is in contact with the developer carrying member, is below a rotation center of the developer carrying member and is between the rotation center of the developer carrying member and a rotation center of the supply member in a horizontal direction.

5. The developing device according to claim 1, wherein
the regulating member has an elastic support member and a resin layer that is provided on a surface of the support member and is in contact with the developer carrying member; and
the protrusion is molded integrally as part of the resin layer.

6. The developing device according to claim 1, wherein the developer is a nonmagnetic mono-component toner.

7. A process cartridge that can be detachably attached to an apparatus main body of an image forming apparatus, the process cartridge comprising:
the developing device according to claims 1; and
an image bearing member on which a latent image that is to be developed by the developing device is formed.

8. An image forming apparatus that forms an image on a recording material, the image forming apparatus comprising:
the developing device according to claim 1; and
an image bearing member on which a latent image that is to be developed by the developing device is formed, wherein
a developer image which has been formed on the image bearing member by the development of the latent image is transferred to the recording material.

9. The image forming apparatus according to claim 8, further comprising an intermediate transfer member which is disposed above the image bearing member, and onto which the developer image formed on the image bearing member is transferred, and moreover which transfers the transferred developer image to the recording material.

10. A developing device for use in an image forming apparatus, the developing device comprising:
a frame that accommodates a developer;
a developer carrying member that is rotatably provided in an opening of the frame and carries and transports the developer;
a supply member that supplies the developer to the developer carrying member, the supply member being in contact with the developer carrying member and being provided rotatably so as to move in the same direction with respect to the rotating developer carrying member at a contact portion thereof; and
a regulating member that is blade-shaped, one end of the regulating member being fixed to the frame, and the other end of the regulating member, which is a free end extending in a direction opposite to a rotation direction of the developer carrying member, being in contact with the developer carrying member,
wherein
the regulating member comprising,
an opposing portion that faces the developer carrying member, and
a protrusion that protrudes toward the developer carrying member in the opposing portion facing the developer carrying member is provided;
wherein the opposing portion comprising an opposing surface that faces the developer carrying member at a position further toward a tip side of the other end than the protrusion; and
wherein a height of the protrusion from the opposing surface is denoted by H (mm) and a length of the opposing surface extending toward the tip side perpendicular to an axial line direction of the developer carrying member is denoted by L (mm), when viewing a cross section perpendicular to a rotation axis of the developer carrying member, the following conditions are satisfied:
0.05≦H≦0.1, and
0.15≦L≦1.0.

11. The developing device according to claim 10, wherein
the frame has a developing chamber, which is provided with the opening and in which the developer carrying member and the supply member are disposed, and an accommodating chamber, which is below the developing chamber, communicates with the developing chamber, and accommodates the developer,
the developing device further comprising a transport member that is rotatably disposed in the accommodating chamber and transports the developer from the accommodating chamber to the developing chamber.

12. The developing device according to claim 10, wherein
a revolution speed of the supply member is higher than that of the developer carrying member.

13. The developing device according to claim 10, wherein
a position, at which the protrusion of the regulating member, is in contact with the developer carrying member is below a rotation center of the developer carrying member and is between the rotation center of the developer carrying member and a rotation center of the supply member in a horizontal direction.

14. The developing device according to claim 10, wherein
the regulating member has an elastic support member and a resin layer that is provided on a surface of the support member and is in contact with the developer carrying member; and
the protrusion is molded integrally as part of the resin layer.

15. The developing device according to claim 10, wherein the developer is a nonmagnetic mono-component toner.

16. A process cartridge that can be detachably attached to an apparatus main body of an image forming apparatus, the process cartridge comprising:
the developing device according to claim 10; and
an image bearing member on which a latent image that is to be developed by the developing device is formed.

17. An image forming apparatus that forms an image on a recording material, the image forming apparatus comprising:
the developing device according to claims 10; and
an image bearing member on which a latent image that is to be developed by the developing device is formed, wherein
a developer image which has been formed on the image bearing member by the development of the latent image is transferred to the recording material.

18. The image forming apparatus according to claim 17, further comprising an intermediate transfer member which is disposed above the image bearing member, and onto which the developer image formed on the image bearing member is transferred, and moreover which transfers the transferred developer image to the recording material.
